(19) United States
(12) Patent Application Publication
(10) Pub. No.: US 2026/0340008 A1
(43) Pub. Date: Oct. 29, 2026

(54) RESEARCH QUERY RESPONSES USING ARTIFICIAL INTELLIGENCE

(71) Applicant: Notion Labs, Inc., San Francisco, CA (US)

(72) Inventors: Michael Jia, San Francisco, CA (US); Quinn Johnson, San Francisco, CA (US); Kenny Kin Fai Leung, San Francisco, CA (US); Sarah Sachs, San Francisco, CA (US); Elias Rimer, San Francisco, CA (US); Luca Beetz, San Francisco, CA (US); Lucas Neumann De Antonio, San Francisco, CA (US); Shannon Rhee, San Francisco, CA (US); Lucy Cheng, San Francisco, CA (US); Simon Townsend-Last, New York, NY (US)

(21) Appl. No.: 19/232,019

(22) Filed: Jun. 9, 2025

Related U.S. Application Data
(60) Provisional application No. 63/796,080, filed on Apr. 28, 2025.

(51) Int. Cl. G06F 16/334; G06F 16/338; G06F 16/93

(52) U.S. Cl. CPC G06F 16/334; G06F 16/338; G06F 16/94

(57) ABSTRACT

The present disclosure provides systems, methods, and computer-readable media for generating a response to a research query using artificial intelligence (AI). A research query is received from a user and a list of available tools is provided to an AI tool. The AI tool is directed to generate a research plan based on the research query and list of available tools. The research plan is received from the first AI tool and executed. The first AI tool determines whether data collected by executing the first research plan is sufficient for a complete response to the research query. If so, the collected data is provided to an AI tool which generates a response to the research query. The response is received and displayed to the user via a user interface (UI).

### CROSS-REFERENCE TO RELATED APPLICATIONS

This application claims priority to and the benefits of U.S. Provisional Application No. 63/796,080, titled “RESEARCH QUERY RESPONSES USING ARTIFICIAL INTELLIGENCE” filed on Apr. 28, 2025. The content of the aforementioned application is herein incorporated by reference in its entirety.

### BACKGROUND

Artificial intelligence (AI) refers to the capability of computational systems to perform tasks typically associated with human intelligence, such as learning, reasoning, problem-solving, perception, and decision-making. Generative artificial intelligence (sometimes called Generative AI or Gen AI) is a subfield of AI that uses generative models to produce text, images, videos, or other forms of data. These models learn the underlying patterns and structures of their training data and use them to produce new data based on the input, which often comes in the form of natural language prompts.

In recent years, there has been a significant proliferation of software tools which employ AI models, including generative AI models to interpret natural language queries provided as input by a human user and return a natural language response as output. Commercially available tools of this kind include “chatbots” such as ChatGPT, Copilot, Gemini, and LLaMA.

### BRIEF DESCRIPTION OF THE DRAWINGS

Reference will now be made, by way of example, to the accompanying drawings which show example embodiments of the present application, and in which:

FIG. 1 is a block diagram illustrating a platform, which may be used to implement examples of the present disclosure.

FIG. 2 is a block diagram of a transformer neural network, which may be used in examples of the present disclosure.

FIG. 3 is a block diagram illustrating a hierarchical organization of pages in a workspace.

FIG. 4 illustrates an example research environment for generating a response to a research query within a workspace application.

FIG. 5 is an illustration of an example user interface for inputting a user interface into a workspace application.

FIG. 6 is an illustration of an example user interface for displaying progress towards responding to a research query.

FIG. 7 is an illustration of an example user interface for displaying a response to a research query.

FIG. 8 is a flow diagram illustrating an example method of displaying a response to a research query

FIG. 9 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology provides for systems, methods, and computer-readable media for generating a response to a research query using artificial intelligence (AI). A research query is a natural language query describing a research task to be performed, which is a relatively complex information gathering or information synthesis task. For example, the query “Generate a report on the impact of climate change in Mongolia” may be categorized as a research query, while a simpler query such as “What is the largest statue in Mongolia?” may not be categorized as a research query. Because of the complexity of a research query, generating a complete response to a research query generally requires the evaluation of multiple sources of data and the iterative investigation of multiple interrelated ideas/categories of information. Developing an effective plan to respond to a research query therefore demands advanced planning and continuous adaptation to newly uncovered information.

Existing AI tools for generating responses to queries have developed relatively advanced capabilities for interpreting the semantic meaning of queries received by these tools. However, these AI tools typically follow a linear process when responding to a query in which a single set of search operations is performed to collect data for responding to the query. Such a process is ineffective at synthesizing data associated with different but interrelated ideas, as is often needed to fully respond to a research query and does not adapt to newly learned information as data is collected. Furthermore, linear search processes are unable to learn about the format of a data source and then return to the source to search it in a more efficient/thorough manner, meaning these search processes are ineffective at extracting data from sources that may have customized categories of data and/or filtering systems that the AI tool does not recognize upon first encountering the data source.

The present technology overcomes these limitations of existing tools by providing a research mode tool which uses an AI tool with planning capabilities to generate a research plan for responding to a research query. The research plan is a set of instructions for collecting data using various tools (e.g., tools within a workspace application, tools for accessing third-party applications, web search tools, other AI tools). This research plan can be executed to collect an intelligently selected set of data which is then evaluated by the AI tool to determine if the collected data is sufficient for a complete response to the research query. When the data is deemed insufficient for a complete response, the planning and data collection processes are iteratively repeated until the collected data is sufficient. Thus, the present technology continuously adapts to newly obtained data and continuously evaluates progress being made towards responding to a research question, unlike existing AI tools which perform linear processes without adaptation/self-evaluation functionalities. This iterative approach to responding to research queries enables the present technology to generate more complete and nuanced responses to research queries than other technologies, thereby more effectively addressing the often complex questions posed by research queries.

Additionally, existing AI tools are not integrated into a workspace application providing other productivity tools such as pages and databases for storing data, as well as complimentary web and AI search tools. Thus, existing AI tools are ineffective at using data from within a user's workspace application to more effectively respond to a research query from the user and may struggle to search through certain data sources that are more effectively searched by other tools. Responses generated by these AI tools may often reside only within an interface of the AI tool, requiring manual effort to save and/or share the response before the response is lost.

The present technology overcomes these limitations as well by integrating the research mode tool within a workspace application. The research mode tool utilizes an AI tool with research planning capabilities to generate a response to a research query. Because the research mode tool is integrated in the workspace application, the research mode tool can access data associated with a querying user from elsewhere in the workspace application, enabling responses to be better tailored to that user. Furthermore, the research mode tool can output responses that are automatically stored within the workspace application and are accessible/shareable to other users by the user, resulting in a smoother response collection and distribution process than existing tools.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Block Data Model

The disclosed technology includes a block data model (“block model”). The blocks are dynamic units of information that can be transformed into other block types and move across workspaces. The block model allows users to customize how their information is moved, organized, and shared. Hence, blocks contain information but are not siloed.

Blocks are singular pieces that represent all units of information inside an editor. In one example, text, images, lists, a row in a database, etc., are all blocks in a workspace. The attributes of a block determine how that information is rendered and organized. Every block can have attributes including an identifier (ID), properties, and type. Each block is uniquely identifiable by its ID. The properties can include a data structure containing custom attributes about a specific block. An example of a property is “title,” which stores text content of block types such as paragraphs, lists, and the title of a page. More elaborate block types require additional or different properties, such as a page block in a database with user-defined properties. Every block can have a type, which defines how a block is displayed and how the block's properties are interpreted.

A block has attributes that define its relationship with other blocks. For example, the attribute “content” is an array (or ordered set) of block IDs representing the content inside a block, such as nested bullet items in a bulleted list or the text inside a toggle. The attribute “parent” is the block ID of a block's parent, which can be used for permissions. Blocks can be combined with other blocks to track progress and hold all project information in one place.

A block type is what specifies how the block is rendered in a user interface (UI), and the block's properties and content are interpreted differently depending on that type. Changing the type of a block does not change the block's properties or content—it only changes the type attribute. The information is thus rendered differently or even ignored if the property is not used by that block type. Decoupling property storage from block type allows for efficient transformation and changes to rendering logic and is useful for collaboration.

Blocks can be nested inside of other blocks (e.g., infinitely nested subpages inside of pages). The content attribute of a block stores the array of block IDs (or pointers) referencing those nested blocks. Each block defines the position and order in which its content blocks are rendered. This hierarchical relationship between blocks and their render children are referred to herein as a “render tree.” In one example, page blocks display their content in a new page, instead of rendering it indented in the current page. To see this content, a user would need to click into the new page.

In the block model, indentation is structural (e.g., reflects the structure of the render tree). In other words, when a user indents something, the user is manipulating relationships between blocks and their content, not just adding a style. For example, pressing Indent in a content block can add that block to the content of the nearest sibling block in the content tree.

Blocks can inherit permissions of blocks in which they are located (which are above them in the tree). Consider a page: to read its contents, a user must be able to read the blocks within that page. However, there are two reasons one cannot use the content array to build the permissions system. First, blocks are allowed to be referenced by multiple content arrays to simplify collaboration and a concurrency model. But because a block can be referenced in multiple places, it is ambiguous which block it would inherit permissions from. The second reason is mechanical. To implement permission checks for a block, one needs to look up the tree, getting that block's ancestors all the way up to the root of the tree (which is the workspace). Trying to find this ancestor path by searching through all blocks'content arrays is inefficient, especially on the client. Instead, the model uses an “upward pointer”—the parent attribute—for the permission system. The upward parent pointers and the downward content pointers mirror each other.

A block's life starts on the client. When a user takes an action in the interface—typing in the editor, dragging blocks around a page—these changes are expressed as operations that create or update a single record. The “records” refer to persisted data, such as blocks, users, workspaces, etc. Because many actions usually change more than one record, operations are batched into transactions that are committed (or rejected) by the server as a group.

Creating and updating blocks can be performed by, for example, pressing Enter on a keyboard. First, the client defines all the initial attributes of the block, generating a new unique ID, setting the appropriate block type (to_do), and filling in the block's properties (an empty title, and checked: [[“No”]]). The client builds operations to represent the creation of a new block with those attributes. New blocks are not created in isolation: blocks are also added to their parent's content array so they are in the correct position in the content tree. As such, the client also generates an operation to do so. All these individual change operations are grouped into a transaction. Then, the client applies the operations in the transaction to its local state. New block objects are created in memory and existing blocks are modified. In native apps, the model caches all records that are accessed locally in an LRU (least recently used) cache on top of SQLite or IndexedDB, referred to as RecordCache. When records are changed on a native app, the model also updates the local copies in RecordCache. The editor re-renders to draw the newly created block onto the display. At the same time, the transaction is saved into TransactionQueue, the part of the client responsible for sending all transactions to the model's servers so that the data is persisted and shared with collaborators. TransactionQueue stores transactions safely in IndexedDB or SQLite (depending on the platform) until they are persisted by the server or rejected.

A block can be saved on a server to be shared with others. Usually, TransactionQueue sits empty, so the transaction to create the block is sent to the server in an application programming interface (API) request. In one example, the transaction data is serialized to JSON and posted to the /saveTransactions API endpoint. SaveTransactions gets the data into source-of-truth databases, which store all block data as well as other kinds of persisted records. Once the request reaches the API server, all the blocks and parents involved in the transaction are loaded. This gives a “before” picture in memory. The block model duplicates the “before” data that had just been loaded in memory. Next, the block model applies the operations in the transaction to the new copy to create the “after” data. Then the model uses both “before” and “after” data to validate the changes for permissions and data coherency. If everything checks out, all created or changed records are committed to the database—meaning the block has now officially been created. At this point, a “success” HTTP response to the original API request is sent by the client. This confirms that the client knows the transaction was saved successfully and that it can move on to saving the next transaction in the TransactionQueue. In the background, the block model schedules additional work depending on the kind of change made for the transaction. For example, the block model can schedule version history snapshots and indexing block text for a Quick Find function. The block model also notifies MessageStore, which is a real-time updates service, about the changes that were made.

The block model provides real-time updates to, for example, almost instantaneously show new blocks to members of a teamspace. Every client can have a long-lived WebSocket connection to the MessageStore. When the client renders a block (or page, or any other kind of record), the client subscribes to changes of that record from MessageStore using the WebSocket connection. When a team member opens the same page, the member is subscribed to changes of all those blocks. After changes have been made through the saveTransactions process, the API notifies MessageStore of new recorded versions. MessageStore finds client connections subscribed to those changing records and passes on the new version through their WebSocket connection. When a team member's client receives version update notifications from MessageStore, it verifies that version of the block in its local cache. Because the versions from the notification and the local block are different, the client sends a syncRecordValues API request to the server with the list of outdated client records. The server responds with the new record data. The client uses this response data to update the local cache with the new version of the records, then re-renders the UI to display the latest block data.

Blocks can be shared instantaneously with collaborators. In one example, a page is loaded using only local data. On the web, block data is pulled from being in memory. On native apps, loading blocks that are not in memory are loaded from the RecordCache persisted storage. However, if missing block data is needed, the data is requested from an API. The API method for loading the data for a page is referred to herein as loadPageChunk; it descends from a starting point (likely the block ID of a page block) down the content tree and returns the blocks in the content tree plus any dependent records needed to properly render those blocks. Several layers of caching for loadPageChunk are used, but in the worst case, this API might need to make multiple trips to the database as it recursively crawls down the tree to find blocks and their record dependencies. All data loaded by loadPageChunk is put into memory (and saved in the RecordCache if using the app). Once the data is in memory, the page is laid out and rendered using React.

### Software Platform

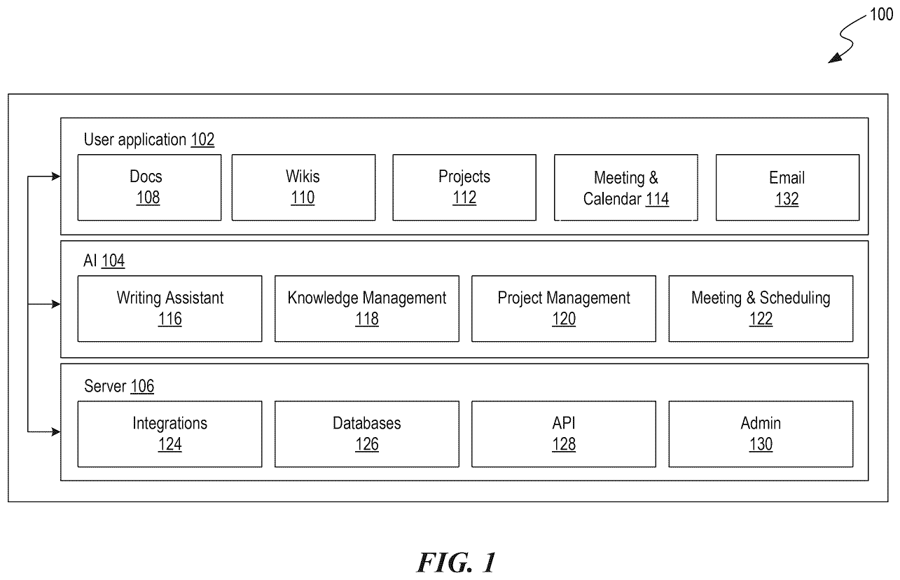

FIG. 1 is a block diagram of an example platform 100. The platform 100 provides users with an all-in-one workspace for data and project management. The platform 100 can include a user application 102, an artificial intelligence (AI) tool 104, and a server 106. The user application 102, the AI tool 104, and the server 106 are in communication with each other via a network.

In some implementations, the user application 102 is a cross-platform software application configured to work on several computing platforms and web browsers. The user application 102 can include a variety of templates. A template refers to a prebuilt page that a user can add to a workspace within the user application 102. The templates can be directed to a variety of functions. Exemplary templates include a docs template 108, a wikis template 110, a projects template 112, a meeting and calendar template 114, and an email template 132. In some implementations, a user can generate, save, and share customized templates with other users.

The user application 102 templates can be based on content “blocks.” For example, the templates of the user application 102 include a predefined and/or pre-organized set of blocks that can be customized by the user. Blocks are content containers within a template that can include text, images, objects, tables, maps, emails, and/or other pages (e.g., nested pages or subpages). Blocks can be assigned to certain properties. The blocks are defined by boundaries having dimensions. The boundaries can be visible or non-visible for users. For example, a block can be assigned as a text block (e.g., a block including text content), a heading block (e.g., a block including a heading), or a sub-heading block having a specific location and style to assist in organizing a page. A block can be assigned as a list block to include content in a list format. A block can be assigned as an AI prompt block (also referred to as a “prompt block”) that enables a user to provide instructions (e.g., prompts) to the AI tool 104 to perform functions. A block can also be assigned to include audio, video, or image content.

A user can add, edit, and remove content from the blocks. The user can also organize the content within a page by moving the blocks around. In some implementations, the blocks are shared (e.g., by copying and pasting) between the different templates within a workspace. For example, a block embedded within multiple templates can be configured to show edits synchronously.

The docs template 108 is a document generation and organization tool that can be used for generating a variety of documents. For example, the docs template 108 can be used to generate pages that are easy to organize, navigate, and format. The wikis template 110 is a knowledge management application having features similar to the pages generated by the docs template 108 but that can additionally be used as a database. The wikis template 110 can include, for example, tags configured to categorize pages by topic and/or include an indication of whether the provided information is verified to indicate its accuracy and reliability. The projects template 112 is a project management and note-taking software tool. The projects template 112 can allow the users, either as individuals or as teams, to plan, manage, and execute projects in a single forum. The meeting and calendar template 114 is a tool for managing tasks and timelines. In addition to traditional calendar features, the meeting and calendar template 114 can include blocks for categorizing and prioritizing scheduled tasks, generating to-do and action item lists, tracking productivity, etc. The various templates of the user application 102 can be included under a single workspace and include synchronized blocks. For example, a user can update a project deadline on the projects template 112, which can be automatically synchronized to the meeting and calendar template 114. The various templates of the user application 102 can be shared within a team, allowing multiple users to modify and update the workspace concurrently.

The email template 132 allows the users to customize their inbox by representing the inbox as a customizable database where the user can add custom columns and create custom views with layouts. One view can include multiple layouts including a calendar layout, a summary layout, and an urgent information layout. Each view can include a customized structure including custom criteria, custom properties, and custom actions. The custom properties can be specific to a view such as AI-extracted properties and/or heuristic-based properties. The custom actions can trigger automatically when a message enters the view. The custom actions can include deterministic rules like “Archive this,” or assistant workflows like responding to support messages by searching user applications 102 or filing support tickets. In addition, the view can include actions, such as buttons, that are custom to the view and perform operations on the messages in the inbox. Only the customized structure can be shared with other users of the system, or both the customized structure and the messages can be shared.

The integration of the docs template 108, the wikis template 110, the projects template 112, the meeting and calendar template 114, and the email template 132 enables linking and embedding of templates within other templates. For example, an email sent from an email address within the platform 100 to another email address within the platform 100 can include an embedding of a document within the platform 100, or an embedding of a block within the document. In another example, a wiki can link to a meeting within the calendar.

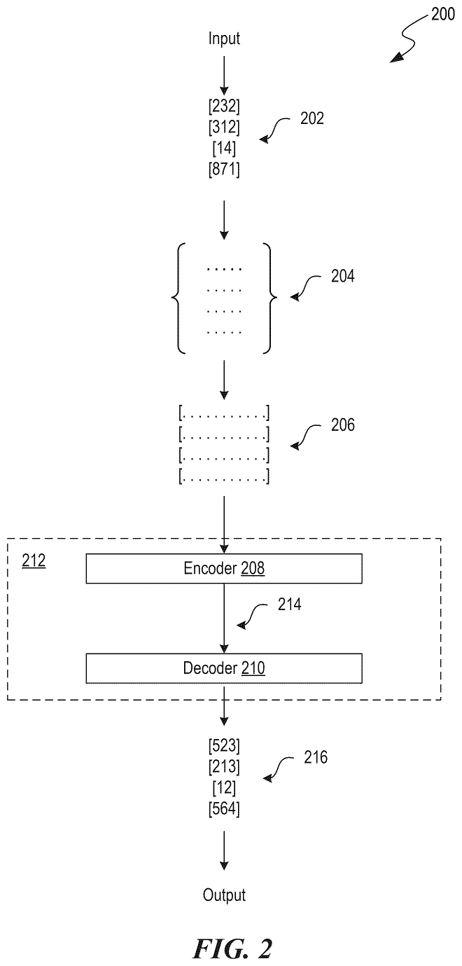

The AI tool 104 is an integrated AI assistant that enables AI-based functions for the user application 102. In one example, the AI tool 104 is based on a neural network architecture, such as the transformer 212 described in relation to FIG. 2. The AI tool 104 can interact with blocks embedded within the templates on a workspace of the user application 102. For example, the AI tool 104 can include a writing assistant tool 116, a knowledge management tool 118, a project management tool 120, and a meeting and scheduling tool 122. The different tools of the AI tool 104 can be interconnected and interact with different blocks and templates of the user application 102.

The writing assistant tool 116 can operate as a generative AI tool for creating content for the blocks in accordance with instructions received from a user. Creating the content can include, for example, summarizing, generating new text, or brainstorming ideas. For example, in response to a prompt received as a user input that instructs the AI to describe what the climate is like in New York, the writing assistant tool 116 can generate a block including text that describes the climate in New York. As another example, in response to a prompt that requests ideas on how to name a pet, the writing assistant tool 116 can generate a block including a list of creative pet names. The writing assistant tool 116 can also operate to modify existing text. For example, the writing assistant can shorten, lengthen, or translate existing text, correct grammar and typographical errors, or modify the style of the text (e.g., a social media style versus a formal style).

The knowledge management tool 118 can use AI to categorize, organize, and share knowledge included in the workspace. In some implementations, the knowledge management tool 118 can operate as a question-and-answer assistant. For example, a user can provide instructions on a prompt block to ask a question. In response to receiving the question, the knowledge management tool 118 can provide an answer to the question, for example, based on information included in the wikis template 110. The project management tool 120 can provide AI support for the projects template 112. The AI support can include autofilling information based on changes within the workspace or automatically tracking project development. For example, the project management tool 120 can use AI for task automation, data analysis, real-time monitoring of project development, allocation of resources, and/or risk mitigation. The meeting and scheduling tool 122 can use AI to organize meeting notes, unify meeting records, list key information from meeting minutes, and/or connect meeting notes with deliverable deadlines.

The server 106 can include various units (e.g., including compute and storage units) that enable the operations of the AI tool 104 and workspaces of the user application 102. The server 106 can include an integrations unit 124, an application programming interface (API) 128, databases 126, and an administration (admin) unit 130. The databases 126 are configured to store data associated with the blocks. The data associated with the blocks can include information about the content included in the blocks, the function associated with the blocks, and/or any other information related to the blocks. The API 128 can be configured to communicate the block data between the user application 102, the AI tool 104, and the databases 126. The API 128 can also be configured to communicate with remote server systems, such as AI systems. For example, when a user performs a transaction within a block of a template of the user application 102 (e.g., in a docs template 108), the API 128 processes the transaction and saves the changes associated with the transaction to the database 126. The integrations unit 124 is a tool connecting the platform 100 with external systems and software platforms. Such external systems and platforms can include other databases (e.g., cloud storage spaces), messaging software applications, or audio or video conference applications. The administration unit 130 is configured to manage and maintain the operations and tasks of the server 106. For example, the administration unit 130 can manage user accounts, data storage, security, performance monitoring, etc.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others. Unlike discriminative models, generative models are distinguished by their ability to create new, synthetic data that closely resembles the training data. In contrast, discriminative models focus on predicting labels for given inputs.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses large language models (LLMs).

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as RNN-based language models.

FIG. 2 is a block diagram 200 of an example transformer 212. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as RNN-based language models.

The transformer 212 includes an encoder 208 (which can include one or more encoder layers/blocks connected in series) and a decoder 210 (which can include one or more decoder layers/blocks connected in series). Generally, the encoder 208 and the decoder 210 each include multiple neural network layers, at least one of which can be a self-attention layer. The parameters of the neural network layers can be referred to as the parameters of the language model.

The transformer 212 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 212 is trained to perform certain functions on other input formats than natural language input. For example, the input can include objects, images, audio content, or video content, or a combination thereof.

The transformer 212 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 2 illustrates an example of how the transformer 212 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 2, a short sequence of tokens 202 corresponding to the input text is illustrated as input to the transformer 212. Tokenization of the text sequence into the tokens 202 can be performed by some pre-processing tokenization module such as, for example, a byte-pair encoding tokenizer (the “pre” referring to the tokenization occurring prior to the processing of the tokenized input by the LLM), which is not shown in FIG. 2 for brevity. In general, the token sequence that is inputted to the transformer 212 can be of any length up to a maximum length defined based on the dimensions of the transformer 212. Each token 202 in the token sequence is converted into an embedding vector 206 (also referred to as “embedding 206”).

An embedding 206 is a learned numerical representation (such as, for example, a vector) of a token that captures some semantic meaning of the text segment represented by the token 202. The embedding 206 represents the text segment corresponding to the token 202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 206 corresponding to the “write” token will be closer to another embedding corresponding to the “jot down” token in the vector space as compared to the distance between the embedding 206 corresponding to the “write” token and another embedding corresponding to the “summary” token.

The vector space can be defined by the dimensions and values of the embedding vectors. Various techniques can be used to convert a token 202 to an embedding 206. For example, another trained ML model can be used to convert the token 202 into an embedding 206. In particular, another trained ML model can be used to convert the token 202 into an embedding 206 in a way that encodes additional information into the embedding 206 (e.g., a trained ML model can encode positional information about the position of the token 202 in the text sequence into the embedding 206). In some implementations, the numerical value of the token 202 can be used to look up the corresponding embedding in an embedding matrix 204, which can be learned during training of the transformer 212.

The generated embeddings 206 are input into the encoder 208. The encoder 208 serves to encode the embeddings 206 into feature vectors 214 that represent the latent features of the embeddings 206. The encoder 208 can encode positional information (i.e., information about the sequence of the input) in the feature vectors 214. The feature vectors 214 can have very high dimensionality (e.g., on the order of thousands or tens of thousands), with each element in a feature vector 214 corresponding to a respective feature. The numerical weight of each element in a feature vector 214 represents the importance of the corresponding feature. The space of all possible feature vectors 214 that can be generated by the encoder 208 can be referred to as a latent space or feature space.

Conceptually, the decoder 210 is designed to map the features represented by the feature vectors 214 into meaningful output, which can depend on the task that was assigned to the transformer 212. For example, if the transformer 212 is used for a translation task, the decoder 210 can map the feature vectors 214 into text output in a target language different from the language of the original tokens 202. Generally, in a generative language model, the decoder 210 serves to decode the feature vectors 214 into a sequence of tokens. The decoder 210 can generate output tokens 216 one by one. Each output token 216 can be fed back as input to the decoder 210 in order to generate the next output token 216. By feeding back the generated output and applying self-attention, the decoder 210 can generate a sequence of output tokens 216 that has sequential meaning (e.g., the resulting output text sequence is understandable as a sentence and obeys grammatical rules). The decoder 210 can generate output tokens 216 until a special [EOT] token (indicating the end of the text) is generated. The resulting sequence of output tokens 216 can then be converted to a text sequence in post-processing. For example, each output token 216 can be an integer number that corresponds to a vocabulary index. By looking up the text segment using the vocabulary index, the text segment corresponding to each output token 216 can be retrieved, the text segments can be concatenated together, and the final output text sequence can be obtained.

In some implementations, the input provided to the transformer 212 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API (e.g., the API 128 in FIG. 1). As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Hierarchical Organizational Blocks in a Workspace

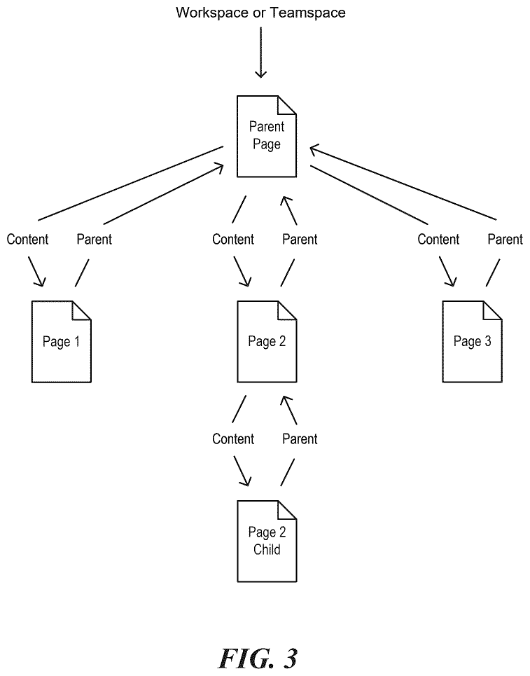

FIG. 3 is a block diagram illustrating a hierarchical organization of pages in a workspace. As described with respect to the block data model of the present technology, a workspace can include multiple pages (e.g., page blocks). The pages (e.g., including parent pages and child or nested pages) can be arranged hierarchically within the workspace or one or more teamspaces, as shown in FIG. 3. The page can include a block such as tabs, lists, images, tables, etc.

A teamspace can refer to a collaborative space associated with a team or an organization that is hierarchically below a workspace. For example, a workspace can include a teamspace accessible by all users of an organization and multiple teamspaces that are accessible by users of different teams. Accessibility generally refers to creating, editing, and/or viewing content (e.g., pages) included in the workspace or the one or more teamspaces.

In the hierarchical organization illustrated in FIG. 3, a parent page (e.g., “Parent Page”) is located hierarchically below the workspace or a teamspace. The parent page includes three children pages (e.g., “Page 1,” “Page 2,” and “Page 3”). Each of the child pages can further include subpages (e.g., “Page 2 Child,” which is a grandchild of “Parent Page” and child of “Page 2”). The “Content” arrows in FIG. 3 indicate the relationship between the parents and children while the “Parent” arrows indicate the inheritance of access permissions. The child pages inherit access permission from the (immediate) parent page under which they are located hierarchically (e.g., which is above them in the tree). For example, “Page 2” inherited the access permission of the “Parent Page” as a default when it was created under its parent page. Similarly, “Page 2 Child” inherited the access permission of the parent page as a default when it was created under its parent page. “Parent Page,” “Page 2,” and “Page 2 Child” thereby have the same access permission within the workspace.

The relationships and organization of the content can be modified by changing the location of the pages. For example, when a child page is moved to be under a different parent, the child page's access permission modifies to correspond to the access permission of the new parent. Also, when the access permission of “Parent Page” is modified, the access permission of “Page 1,” “Page 2,” and “Page 3” can be automatically modified to correspond to the access permission of “Parent Page” based on the inheritance character of access permissions.

In contrast, however, a user can modify the access permission of the children independently of their parents. For example, the user can modify the access permission of “Page 2 Child” in FIG. 3 so that it is different from the access permission of “Page 2” and “Parent Page.” The access permission of “Page 2 Child” can be modified to be broader or narrower than the access permission of its parents. As an example, “Page 2 Child” can be shared on the internet while “Page 2” is only shared internally to the users associated with the workspace. As another example, “Page 2 Child” can be shared only with an individual user while “Page 2” is shared with a group of users (e.g., a team of the organization associated with the workspace). In some implementations, the hierarchical inheritance of the access permissions described herein can be modified from the previous description. For example, the access permissions of all the pages (parent and children) can be defined as independently changeable.

### Example Research Environment

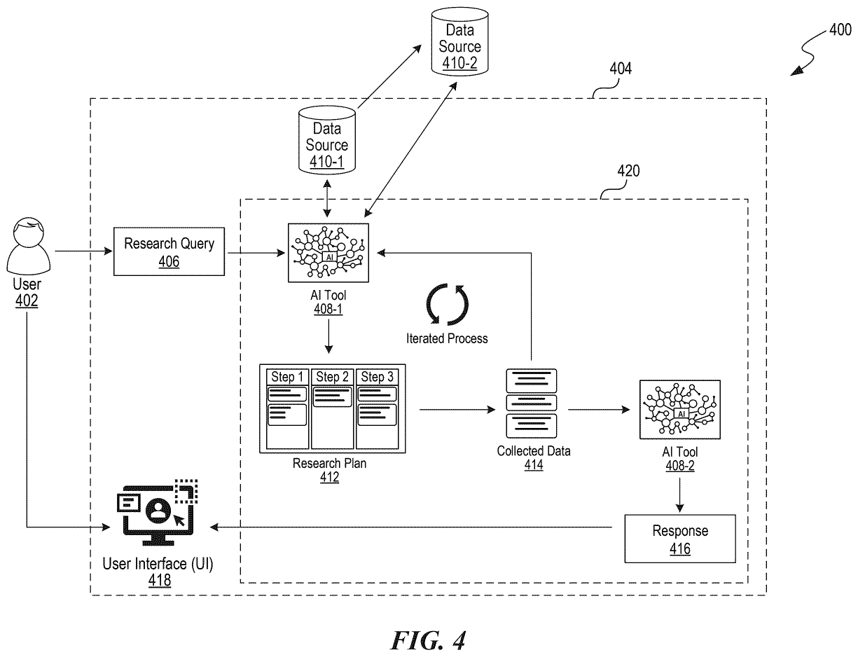

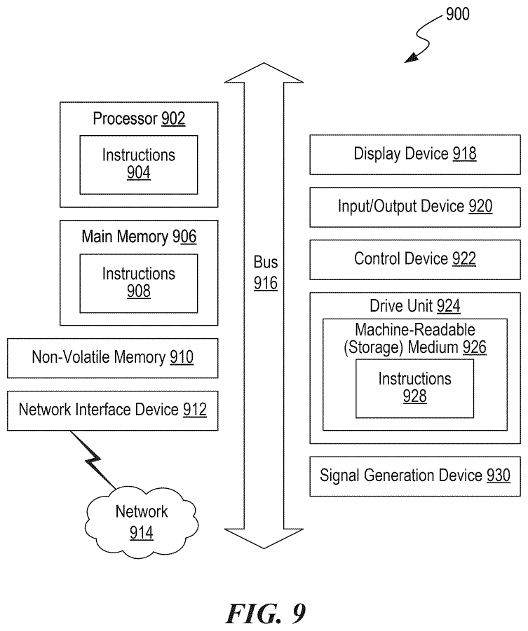

FIG. 4 illustrates an example research environment 400 for generating a response to a research query within a workspace application 404. The research environment 400 includes a user 402, the workspace application 404, a research query 406, data sources 410-1 and 410-2, a research mode tool 420 including AI tools 408-1 and 408-2, a research plan 412, collected data 414, a response 416, and a user interface (UI) 418. The research environment 400 may be implemented using the computer system illustrated and described in more detail with reference to FIG. 9. Likewise, implementations of the research environment 400 can include different and/or additional components or can be connected in different ways.

The user 402 is an individual or entity with access to the workspace application 404, which is an application or other software component providing a suite of tools for data and/or project management (e.g., Notion®). As depicted in FIG. 4, one of the tools provided by the workspace application is a research mode tool 420 where multiple AI tools 408 of the workspace application 404 are used to generate a response 416 to a research query 406. The research query 406 is a natural language query received from the user 402 via a text interface, audio interface, and/or another interface of the workspace application 404 that describes a research task (e.g., a complex information gathering and/or synthesis task) the user 402 wishes the research mode tool 420 to respond to. The user 402 may attach additional context to the research query 406 (e.g., documents, pages within the workspace application 404) which include information related to the research query 406. In some embodiments, the research task is at least partially related to information stored within the workspace application 404 (e.g., “write me a report on last month's sales,” where information about last month's sales is included in a database of the workspace application 404).

In some embodiments, the processes of the research mode tool 420 are only activated after a determination that the research query 406 is complex. The complexity of the research query 406 distinguishes it from other, simpler queries which may be processed by the workspace application 404 using tools other than the research mode tool 420 (e.g., a linear AI search tool using retrieval augmented generation (RAG)). Simpler tools may provide an adequate response to these less complex queries without expending the higher computational and monetary resources required to execute the research mode tool 420; thus, determining the complexity of the research query 406 allows the workspace application 404 to allocate resources more efficiently. For example, the research query 406 may be determined to be complex based on a data environment property, which is a property of the data to be searched while generating a response 416 to the research query 406 such as the number of data sources to be searched, the ambiguity/subjectivity of the data, the amount of data, the location of the data, and/or the trustworthiness of the data. As another example, the research query 406 may be determined to be complex based on a user query property, which is a characteristic of the research query 406 itself, such as the specificity of the research query 406, the number of different tasks specified by the research query 406, ambiguity in the research query 406, and/or implicit context in the research query 406. As a third example, the research query 406 may be determined to be complex based on a user specification of the research query's 406 complexity (e.g., a selection via a UI of the workspace application 404 to treat the research query 406 as complex or a text input describing a high level of complexity for the research query 406).

A first AI tool 408-1 performs the first stage of processing of the research mode tool 420. The first AI tool 408-1 may be an AI tool 104 as described in relation to FIG. 1 above, may include a commercial AI model such as GPT-4 or Claude 3.7 Sonnet, and/or may include code for invoking such a commercial AI model. The AI tool 408-1 is configured to receive the research query 406 and any additional context provided alongside the research query 406 as input and generate a research plan 412 as output. The research plan 412 is a set of instructions to collect data for responding to the research query 406, where each instruction in the set of instructions is executable by the workspace application 404 and/or a software component communicatively coupled to the workspace application 404.

In some embodiments, the first AI tool 408-1 generates the research plan 412 by determining a first data source 410-1 relevant to answering the research query 406 and obtaining a second data source 410-2 connected to the first source. For example, the first data source 410-1 may be a connected data source included in the workspace application 404 (e.g., as a page, database, or other block) and may be determined relevant to answering the research query 406 by the AI tool 408-1 invoking an AI model or ML model to detect a semantic similarity between the data included in the first data source 410-1 and the subject of the research query 406 and/or the additional context provided. In some embodiments, the first data source 410-1 is an AI tool that is generally similar to the first AI tool 408-1 and is likewise hosted within the workspace application 404 but that may invoke a different AI model/ML model from the first AI tool 408-1 to retrieve data from within the workspace application 404 and/or other sources. This AI tool is queried by the first AI tool 408-1 itself and provides an output of data that is received by the first AI tool 408-1. The second data source 410-2 may be a source of data from outside the workspace application 404, such as a third-party application (e.g., an application operated by an entity other than the operator of the workspace application 404), a web source (e.g., a website on the Internet), or a second AI tool that is generally similar to the first AI tool 408-1 but is not hosted within the workspace application 404. The second AI tool may be queried by the first AI tool 408-1 itself and may provide an output of data that is received by the first AI tool 408-1.

Once the first AI tool 408-1 identifies the relevant data sources 410, the first AI tool 408-1 can extract the relevant information from the relevant data sources 410, by, for example, creating a query or a filter. Obtaining only the necessary information from the relevant data sources 410 enables more efficient analysis and computation to generate the research plan.

Additionally or alternatively, the first AI tool 408-1 may generate the research plan 412 based on a list of available tools provided to the first AI tool 408-1 by the workspace application 404. The available tools may include software components for performing operations within the workspace application 404, such as the tools described in relation to FIG. 1 above and/or other tools for accessing the first data source 410-1, tools for accessing the second data source 410-2, and/or an AI tool other than the first AI tool 408-1. Additionally or alternatively, the available tools may include a tool for: 1) performing a web search, 2) searching the workspace application 404, 3) reading a block, 4) reading content hosted in a third-party application and/or a web page, 5) reading content with a filter such that only relevant portions of the content are returned, 6) identifying a property of a database, 7) previewing the content of a database, 8) querying a database, 9) asking a question of the user 402 to clarify the research query 406, 10) coding/script execution, 11) loading information about a user state within the workspace application 404 (e.g., information indicating a part of a page viewable by the user 402, information indicating the position of a mouse cursor of the user, 12) editing a page, and/or 13) rendering a data visualization (e.g., a chart, a database view). The list of available tools, in addition to the first data source 410-1 and second data source 410-2, specify the querying capabilities of the workspace application 404 and thereby enable the first AI tool 408-1 to determine the instructions that may be included in the research plan 412 and be successfully executed by the workspace application 404. In such embodiments, the research plan 412 may be a set of instructions to execute one or more of the available tools from the list of available tools, thereby collecting data for responding to the search query (e.g., resulting in collected data 414 as output, as described below).

In some embodiments, the first AI tool 408-1 generates the research plan 412 based on the research query 406, the first data source 410-1, and/or the second data source 410-2, thereby developing a plan for responding to the research query 406 that addresses the task(s) presented in the research plan 412 and accounts for the particular data available to the research mode tool 420 from the data sources 410. The research plan 412 is then executed (e.g., the instructions in the research plan 412 are performed by one or more tools within the workspace application), resulting in collected data 414 as output. The collected data 414 is a compilation of the data collected while executing the research plan 412 and which may be used to generate a complete or partial response to the research query 406. In some embodiments, a subset of the set of instructions are instructions for collecting data from a database created by the user 402 within the workspace application. Databases are tables containing data associated with one or more blocks. Each row and column of a database may be configured (e.g., to have specific properties) in a manner specific to the user 402 and may be filtered according to a property of a row and/or column. Thus, the multi-step instructions of the research plan 412 is an effective means for extracting data from a database, as the properties of the database may be performed at a first step, one or more filters may be performed at a second step, and so on to account for the particular organization of the database and extract information relevant to the research query 406.

In some embodiments, two or more instructions from the set of instructions in the research plan 412 are selected by the workspace application 404 as being executable in parallel and are executed in parallel (e.g., simultaneously or nearly simultaneously) to increase the speed at which the research mode tool 420 generates a response 416. For example, the two or more instructions may be deemed executable in parallel based on a resource limitation, which indicates enough computational resources are available to execute the instructions in parallel, and/or based on a dependency, which indicates that the proper execution of each instruction in the two or more instructions does not depend on the prior execution of one of the other instructions in the two or more instructions (e.g., no dependency errors will be caused by parallel execution).

In some embodiments, an AI tool (which may be the first AI tool 408-1 or another AI tool) generates a human-readable list of steps based on the first research plan. The human-readable list of steps represents the set of instructions included in the first research plan but is written in natural human language such that the user may read and understand the human-readable list. The human-readable list is then displayed to the user 402 via a user interface 418 of the workspace application 404. In such embodiments, the workspace application 404 may receive from the user 402, via the UI 418, a modification to the research plan 412. The modification may include an addition of an instruction, a deletion of an instruction, and or a supplementary query, which is a natural language query including additional questions/tasks that supplement the initial research query 406 and may be used by the first AI tool 408-1 to modify the research plan 412. The first AI tool 408-1 is then directed to update the research plan 412 based on the modification. Thus, displaying the human-readable list to the user 402 and/or receiving a modification to the research plan 412 from the user enables the user 402 to tailor the research plan 412 to the user's 402 specifications before the research plan is executed by the workspace application 404, helping the workspace application 404 to more efficiently generate a complete response to the research query 406.

In some embodiments, the research mode tool 420 does not immediately proceed with generating a response based on the collected data 414. Instead, the first AI tool 408-1 is directed to determine whether the collected data 414 is sufficient for a complete response to the research query 406. A complete response is a response that, based on the training of the AI tool 408-1, is predicted to be satisfactory to the user 402 and provide the user 402 with enough information to feel as if the research query 406 has been fulfilled. When the first AI tool 408-1 determines that insufficient data was collected in the collected data 414 for a complete response to the research query 406 to be generated, the first AI tool 408-1 will generate a second research plan based on the research query 406 and the collected data 414 designed to collect the missing information needed to completely respond to the research query 406. The first AI tool 408-1 may then execute the second research plan, resulting in an update to the collected data 414.

The process of determining whether the collected data 414 is sufficient for a complete response to the research query 406, developing a new research plan, and executing the new plan to update the collected data 414 may be repeated until the first AI tool 408-1 determines sufficient data has been collected or until a predetermined period of time has passed (e.g., a time as determined by the user 402 or an operator of the workspace application 404), after which the research mode tool 420 must provide a response 416 to the user. By repeatedly iterating through research plans until sufficient data is collected for a complete response, the research mode tool 420 can dynamically navigate through complex sources of data such as databases and/or third-party applications until a response 416 thoroughly addressing the research query 406 can be provided to the user 402. In some embodiments, as the interactive process is repeated, the scope of the data searched while executing research plans is narrowed to conserve computational resources and reduce the time required to identify information that has not already been included in the collected data. For example, after execution of the first research plan 412, subsequent research plans may only include instructions for accessing a subset of the data sources (e.g., the first data source 410-1, the second data source 410-2) accessed while executing the research plan 412, thereby adaptively narrowing the scope of searches performed by the research mode tool 420 and reducing the time and computational resources spent on generating a response 416. Additionally or alternatively, the scope of the data sources may be expanded when the first AI tool 408-1 determines that the data sources accessed while executing the research plan 412 are unlikely to provide the information necessary for a complete response, thereby adaptively increasing the scope of searches when appropriate.

After the collected data 414 is sufficient for a complete response, a second AI tool 408-2 is directed to generate a response 416 to the research query based on the collected data 414. The second AI tool 408-2 may be the same as or generally similar to the first AI tool 408-1 or may be another AI tool. The workspace application 404 receives the response 416 from the second AI tool 408-2 and causes display of the response to the user 402 via the UI 418, thereby allowing the user 402 to review the response 416 and provide follow-up queries to the workspace application 404 if more information is required. In some embodiments, the UI 418 includes a hoverable link that, when hovered over by the user 402 (e.g., when a mouse cursor of the user 402 is placed above the link), causes display of at least one source of data used to generate the response (e.g., the first data source, the second data source). The hoverable link enables the user 402 to investigate the source of the information provided in the response 416 and navigate to the source itself when more information, or verification of information in the response 416, is desired by the user 402.

In some embodiments, the response 416 is saved to a page of the workspace application 404, enabling the response 416 to be stored within the workspace application 404 and interacted with rather than being lost once the user 402 navigates away from the UI 418. In such embodiments, the page is accessible by the user 402 and permissions to access the page may be controllable by the user 402 such that the user 402 may share the page with others and disseminate the response 416 without the need for manually replicating the response 416 or copying a file containing the response 416.

In some embodiments, the first AI tool 408-1 and second AI tool 408-2 have different levels of associated computational complexity tailored to the different tasks performed by the two AI tools. Generating a research plan 412 and intelligently determining whether the collected data 414 is sufficient to answer the research query 406 generally requires the use of one or more AI models, which are highly complex and computationally expensive to execute but which provide more advanced artificial reasoning capabilities than other models. Thus, the first AI tool 408-1 may include and/or invoke an AI model having a first associated level of computational complexity that is higher than the complexity of other AI models. However, other tasks performed by the research mode tool 420 may be performed with a sufficient level of accuracy using lighter AI models that are less computationally complex and expensive to run. Thus, the second AI tool 408-2 and/or AI tools used to collect data, generate the human-readable list of steps, create summaries, and the like may include and/or invoke an AI model having a second associated level of computational complexity that is lower than the first associated level of computational complexity. By using different AI tools 408 with different levels of computational complexity, the research mode tool 420 generated complete responses to research queries without expending excessively large amounts of time or excessive computational resources on processing steps which may be competed quickly using light AI models.

For example, the first AI tool 408-1 can be a state-of-the-art AI tool having trillions of weights, while the second AI tool 408-2 can be a smaller AI model having a billion weights. The difference in the number of weights between the first AI tool 408-1 and the second AI tool 408-2 can be five times or higher. Consequently, the amount of computational cycles and energy utilized by the first AI tool 408-1 is five or more times higher than the computational cycles and energy utilized by the second AI tool 408-2. Thus, by utilizing the second AI tool 408-2 to answer the second question, the system reduces the overall computational cycles and energy used by the AI tools 408.

In some embodiments, the collected data 414 is provided to the second AI tool 408-2 before the collected data 414 has been deemed sufficient for a complete response. In such embodiments, the second AI tool 408-2 is directed to generate an intermediate response to the research query 406, which is received by the workspace application 404 and displayed to the user 402 via the UI 418 to appraise the user 402 of the progress that has been made so far in responding to the research query, partially answer the research query, and/or to highlight the steps within the research plan 412 that have been completed (e.g., the instructions that have been executed). For example, display of the intermediate response may include a status update associated with at least one step from the human-readable list of steps (e.g., “Step 1 is complete,” “Step 2 needs more information”), thereby informing the user 402 in an understandable format of the progress being made by the research mode tool 420.

### Example User Interface Elements

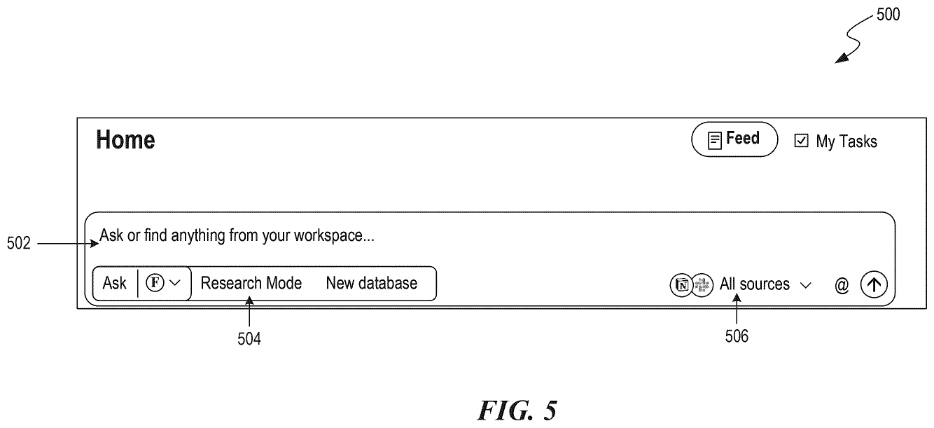

FIG. 5 is an illustration of an example UI 500 for inputting a research query into a workspace application. The UI 500 includes a search bar 502 for a user (e.g., a user 402 as described in relation to FIG. 4 above) to input the research query, which is natural language text describing a research task the user wishes the workspace application (e.g., a workspace application 404 as described in relation to FIG. 4 above) to perform. The user may indicate that a research mode tool (e.g., the research mode tool 420 described in relation to FIG. 4 above) should be used by the workspace application to process the input provided via the search bar 502 by selecting (e.g., clicking with a mouse cursor) the research mode selector 504 included in the UI 500.

The UI 500 also includes a data source selector 506 for selecting the data sources to search while generating a response (e.g., while a workspace application 404 is executing a research plan 412, as described in relation to FIG. 4 above) to the input provided via the search bar 502. The data sources used and/or the tools in a list of available tools within the workspace application may be limited based on a selection received from the user via the data source selector 506 such that data sources which are not selected by the user are not accessed. Data sources may include data within the workspace application (e.g., a page or database), a third-party application (e.g., an application operated by an entity other than the operator of the workspace application), a web source (e.g., a website on the Internet), or an AI tool (e.g., as described in relation to FIG. 4 above).

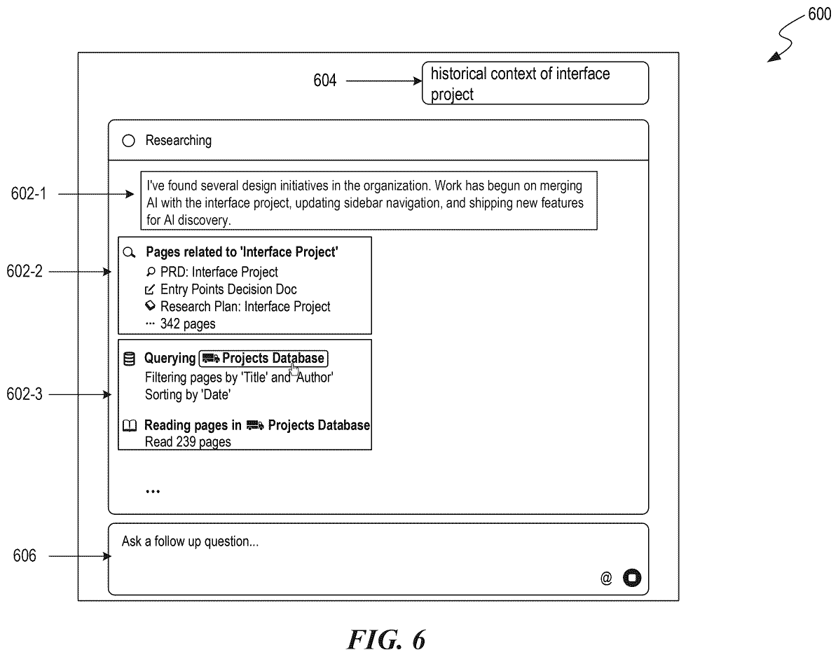

FIG. 6 is an illustration of an example UI 600 for displaying progress towards responding to a research query 604. The UI 600 includes three different intermediate responses 602, which inform the user of different elements of the progress being made (e.g., by a research mode tool 420 as described in relation to FIG. 4) towards responding to a research query 604 provided by the user. As depicted in FIG. 6, intermediate response 602-1 provides a partial answer to the research query 604, which pertains to the historical context of the “interface project,” by explaining related design initiatives and work being done that were uncovered. Intermediate response 602-2 instead provides the user with an update on pages that had already been identified as being related to the research query 604, while intermediate response 602-3 provides a status update associated with two different steps from a human-readable list of steps associated with the research plan being executed, namely, that the “projects” database is being queried and that pages within that database are being read. In some embodiments, the intermediate responses 602 are generated and/or formatted by an AI tool (e.g., the first AI tool 408-1 described in relation to FIG. 4) or a commercial AI model.

The UI 600 also includes a supplementary query bar 606 where a user can input a supplementary query. The supplementary query may include additional questions/tasks that supplement the initial research query and may be used by an AI tool (e.g., the first AI tool 408-1 described in relation to FIG. 4) to modify a research plan that is presently being executed. The AI tool may then be directed to update the research plan based on the supplementary query.

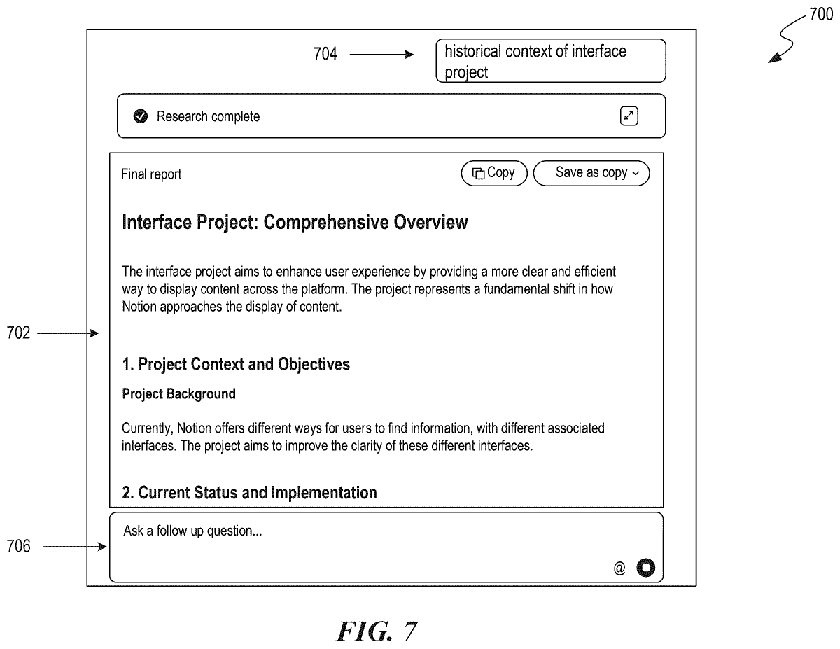

FIG. 7 is an illustration of an example UI 700 for displaying a response 702 to a research query 704. The response 702 is based on data collected from completing the set of instructions making up one or more research plans and provides the user with enough information for the user to feel as if the research query 704 has been fulfilled. For example, the response 702 provides more detailed information than the intermediate responses 602 described in relation to FIG. 6 above, including a paragraph-length overview of the interface project along with details on the project's context, objectives, status, and implementation. The response 702 also includes text indicating the response 702 is a “final report,” indicating to the user that no more information will be added to the response 702 without prompting from the user. Such prompting may be provided via the supplementary query bar 706, which is the same as or generally similar to the supplementary query bar 606 described in relation to FIG. 6 above and may be used by the user to query for additional information not covered in the response 702 and/or answer additional questions raised by the response 702. In some embodiments, citations are included along with the response 702 indicating the sources used to generate the response 702. For example, the citations may include hyperlinks to pages within a workspace application from which information included in the response 702 was extracted.

### Example Response Display Method

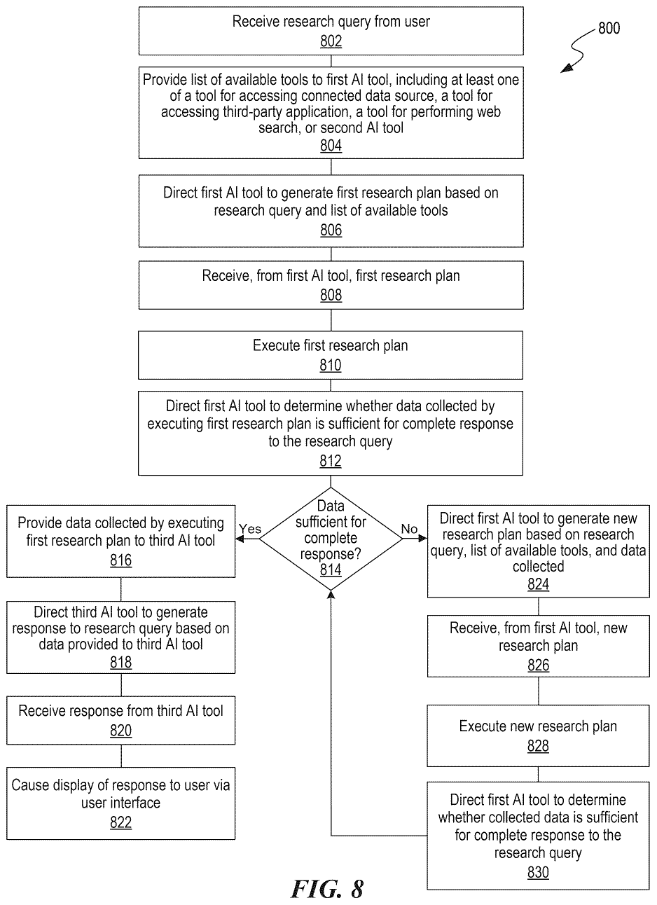

FIG. 8 is a flow diagram illustrating an example method 800 of displaying a response to a research query. In some embodiments, the method 800 is performed by components of the example computer system illustrated and described in more detail in relation to FIG. 9 below and/or the workspace application 404 described in more detail in relation to FIG. 4 above. Likewise, embodiments can include different and/or additional operations or can perform the operations in different orders.

In operation 802, a research query is received from a user. The user and research query may be the same as or generally similar to the user 402 and research query 406 as described in relation to FIG. 4 above. In some embodiments, the research query is input via a search bar 502 of a UI 500, as illustrated in relation to FIG. 5 above. In these and other embodiments, a determination is made that the research query is complex based on at least one of a detected data environment property, a detected query property, or a user specification of complexity. The remaining operations in the method 800 may not be performed when the research query is determined not to be complex.

In operation 804, a list of available tools is provided to a first AI tool, the list including at least one of a tool for accessing a connected data source, a tool for accessing a third-party application, a tool for performing a web search, or a second AI tool. The first AI tool may be the same as or generally similar to the first AI tool 408-1 as described in relation to FIG. 4 above. In some embodiments, the list of available tools is a list of tools available in the workspace application 404, as described in relation to FIG. 4 above. Likewise, the tool for accessing a connected data source, the tool for accessing a third-party application, the tool for performing a web search, and the second AI tool may be the same as or similar to the tools described in relation to the first data source 410-1 and second data source 410-2 of FIG. 4 above.

Additionally or alternatively, the first AI tool may determine a first data source that is included in a workspace application to be relevant to answering the research query and then obtain a second data source connected to the first data source, where the second data source includes a third-party application, a web source, and/or a second AI tool. The first AI tool may then be directed to generate a first research plan based on the research query, the first data source, and the second data source. The first research plan may be the same as or generally similar to the research plan 412 described in relation to FIG. 4 above and may be generated in the same or a generally similar manner as described therein. In some embodiments, the first AI tool makes the determination of the first data source in response to determining the research query is complex.

In operation 806, the first AI tool is directed to generate a first research plan based on the research query and the list of available tools. The first research plan may be the same as or generally similar to the research plan 412 described in relation to FIG. 4 above and may be generated in the same or a generally similar manner as described therein. In some embodiments, the research plan includes a subset of a set of instructions for collecting data from a database created by the user, with the database being a table containing data associated with one or more blocks.

In operation 808, the first research plan is received from the first AI tool, and in operation 810, the first research plan is executed. Executing the first research plan results in the collection of data which may be used to generate a complete or partial response to the research query. In some embodiments, this data is stored as collected data 414, as described in relation to FIG. 4 above. In these and other embodiments, a human-readable list of steps based on the first research plan is generated (e.g., using an AI tool). Display of the human-readable list of steps to the user is then caused via a UI. A modification to the first research plan can be received from the user via the UI. The modification may include at least one of an addition of an instruction to the first research plan, a deletion of an instruction from the first research plan, and/or a supplementary query. After the modification is received, the first AI tool can be directed to update the first research plan based on the modification. Additionally or alternatively, after the human-readable list of steps is generated, an AI tool may be directed to generate an intermediate response to the research query based on data collected by executing the first research plan. The intermediate response may be received from the third AI tool and display of the intermediate response to the user is then caused via a UI. The display of the intermediate response may include a status update associated with at least one step from the human-readable list of steps.

In some embodiments, executing the first research plan includes selecting two or more instructions from the set of instructions that are executable in parallel. This selection can be based on at least one of a resource limitation or a dependency. The selected instructions can then be executed in parallel.

In some embodiments, before the first research plan is executed, a selection of data sources to search while executing the first research plan is received from the user (e.g., via a UI). In such embodiments, the tools in the list of available tools for the first AI tool to use are limited based on the selection of data sources.

In operation 812, the first AI tool is directed to determine whether data collected by executing the first research plan is sufficient for a complete response to the research query. In some embodiments, a complete response is a response that, based on the training of the AI tool, is predicted to be satisfactory to the user and provide the user with enough information to feel as if the research query has been fulfilled.

In operation 814, a different series of operations is chosen within the method 800 depending on the outcome of the determination in operation 812. In embodiments where the data collected by executing the first research plan is sufficient for a complete response, the method 800 proceeds to operation 816, in which the data collected by executing the first research plan is provided to a third AI tool. For example, the third AI tool may be the same as or generally similar to the second AI tool 408-2 described in relation to FIG. 4 above. In some embodiments, the third AI tool (and/or the second AI tool) have lower associated levels of computational complexity than a first level of computational complexity associated with the first AI model. By using different AI tools with different levels of computational complexity, the method may be executed without expending excessively large amounts of time or excessive computational resources on processing steps which may be competed quickly using AI models of lower relative complexity.

In operation 818, the third AI tool is directed to generate a response to the research query based on data provided to the third AI tool. In embodiments where the data collected by executing the first research plan is sufficient for a complete response to the research query upon the first executing of operation 814, the data provided to the third AI tool will be the data collected as a result of executing the first research plan in operation 810. However, different data may be provided to the third AI tool in other embodiments, as described in more detail below.

In operation 820, a response to the research query is received from the third AI tool and in operation 822, display of the response to the user is caused via a UI. In some embodiments, the UI is the same as or generally similar to the UI 418 described in relation to FIG. 4 above and/or may include a hoverable link that, when hovered over by the user, causes display of at least one of the first data source or the second data source. In these and other embodiments, the response is saved to a page accessible by the user and for which permissions to access the page are controllable by the user.

In embodiments where the data collected by executing the first research plan is not sufficient for a complete response, the method 800 proceeds to operation 824, where the first AI tool is directed to generate a new research plan based on the research query, the list of available tools, and the data collected by executing the first research plan. Operation 824 is executed in generally the same manner as operation 806, in which the first AI tool generates the first research plan, except that the data collected by executing the first research plan is used by the first AI model as an additional input. In some embodiments, data sources accessed while executing the new research plan are a subset of the data sources while executing the first research plan.

In operation 826, a new research plan is received from the first AI tool and in operation 828, the new research plan is executed. These operations are generally the same as operations 808 and 810, respectively, except that the particular set of instructions in the new research plan may be different from the set of instructions in the first research plan, as the first AI tool generates the new research plan in order to collect missing data that may be used to generate a complete response to the research query and was not collected after execution of the first research plan. Thus, the execution of the new research plan results in the collection of new data. In some embodiments, the new data is added to the collected data 414, as described in relation to FIG. 4 above.

In operation 830, the first AI tool is directed to determine whether collected data (e.g., data collected by executing the first research plan and the new research plan) is sufficient for a complete response to the research query. This operation is generally the same as operation 812, except that the first AI tool evaluates an expanded collection of data. Operation 814 is then repeated on the determination of operation 830 to determine how the method 800 should proceed. In embodiments where the collected data is still not sufficient for a complete response to the research query, operations 824 through 830 are repeated to collect additional data. These operations may be repeated any number of times until a determination is made that the collected data is sufficient for a complete response. Once the first AI tool determines the collected data is sufficient for a complete response, operations 816 through 822 are executed as described above to display a response to the user via a UI.

In some embodiments, the first AI tool has a first associated level of computational complexity, while the second AI tool, third AI tool, and/or any other additional AI tools (e.g., a fourth AI tool) each have a second associated level of computational complexity that is lower than the first associated level of computational complexity.

### Computer System

FIG. 9 is a block diagram that illustrates an example of a computer system 900 in which at least some operations described herein can be implemented. As shown, the computer system 900 can include: one or more processors 902, main memory 906, non-volatile memory 910, a network interface device 912, a display device 918, an input/output device 920, a control device 922 (e.g., keyboard and pointing device), a drive unit 924 that includes a machine-readable (storage) medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the figures and any other components described in this specification can be implemented.

The computer system 900 can take any suitable physical form. For example, the computer system 900 can share a similar architecture as that of a server computer, personal computer (PC), tablet computer, mobile telephone, wearable electronic device, network-connected (“smart”) device (e.g., a television or home assistant device), augmented reality/virtual reality (AR/VR) system (e.g., head-mounted display), or any electronic device capable of executing a set of instructions that specify action(s) to be taken by the computer system 900. In some implementations, the computer system 900 can be an embedded computer system, a system-on-chip (SOC), a single-board computer (SBC) system, or a distributed system such as a mesh of computer systems or include one or more cloud components in one or more networks. Where appropriate, one or more computer systems 900 can perform operations in real time, near real time, or in batch mode.

The network interface device 912 enables the computer system 900 to mediate data in a network 914 with an entity that is external to the computer system 900 through any communication protocol supported by the computer system 900 and the external entity. Examples of the network interface device 912 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 906, non-volatile memory 910, machine-readable medium 926) can be local, remote, or distributed. Although shown as a single medium, the machine-readable medium 926 can include multiple media (e.g., a centralized/distributed database and/or associated caches and servers) that store one or more sets of instructions 928. The machine-readable medium 926 can include any medium that is capable of storing, encoding, or carrying a set of instructions for execution by the computer system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computer system 900 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” or any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A non-transitory, computer-readable storage medium comprising instructions recorded thereon, wherein the instructions, when executed by at least one data processor of a system, cause the system to:
receive a research query from a user;
determine that the research query is complex based on at least one of a detected data environment property, a detected query property, or a user specification of complexity;
in response to determining that the research query is complex, determine, by a first artificial intelligence (AI) tool, a first data source relevant to answering the research query,
wherein the first data source is included in a workspace application;
from the first data source, obtain by the first AI tool, a second data source connected to the first data source,
wherein the second data source includes at least one of a third-party application, a web source, or a second AI tool;
direct the first AI tool to generate a first research plan based on the research query, the first data source, and the second data source,
wherein the first research plan is a set of instructions to collect data for responding to the research query;
receive, from the first AI tool, the first research plan;
generate, using a third AI tool, a human-readable list of steps based on the first research plan;
cause display of the human-readable list of steps to the user via a user interface;
execute the first research plan;
direct the first AI tool to determine whether the data collected by executing the first research plan is sufficient for a complete response to the research query;
upon receiving an indication from the first AI tool that insufficient data was collected for a complete response to the research query, direct the first AI tool to 1) generate a second research plan based on the research query and the data collected from executing the first research plan and 2) execute the second research plan;
direct a fourth AI tool to generate a response to the research query based on data collected by executing at least one of the first research plan or the second research plan;
receive, from the fourth AI tool, the response; and
cause display of the response to the user via the user interface.

2. The non-transitory, computer-readable storage medium of claim 1, further comprising instructions to:
receive, from the user via the user interface, a modification to the first research plan,
wherein the modification includes at least one of an addition of an instruction to the first research plan, a deletion of an instruction from the first research plan, or a supplementary query; and
direct the first AI tool to update the first research plan based on the modification.

3. The non-transitory, computer-readable storage medium of claim 1, further comprising instructions to:
direct the fourth AI tool to generate an intermediate response to the research query based on data collected by executing the first research plan;
receive, from the fourth AI tool, the intermediate response; and
cause display of the intermediate response to the user via the user interface,
wherein display of the intermediate response includes a status update associated with at least one step from the human-readable list of steps.

4. The non-transitory, computer-readable storage medium of claim 1, wherein:
the first AI tool has a first associated level of computational complexity; and
the second AI tool, third AI tool, and fourth AI tool each have a second associated level of computational complexity that is lower than the first associated level of computational complexity.

5. The non-transitory, computer-readable storage medium of claim 1, further comprising:
saving the response to a page,
wherein the page is accessible by the user, and
wherein permissions to access the page are controllable by the user.

6. The non-transitory, computer-readable storage medium of claim 1, wherein executing the first research plan comprises:
selecting two or more instructions from the set of instructions that are executable in parallel,
wherein the selection is based on at least one of a resource limitation or a dependency; and
executing the two or more instructions in parallel.

7. The non-transitory, computer-readable storage medium of claim 1, wherein the user interface comprises:
a hoverable link that, when hovered over by the user, causes display of at least one of the first data source or the second data source.

8. A system comprising:
at least one hardware processor; and
at least one non-transitory memory storing instructions, which, when executed by the at least one hardware processor, cause the system to:
receive a research query from a user;
provide a list of available tools to a first artificial intelligence (AI) tool,
wherein the available tools include at least one of a tool for accessing a connected data source, a tool for accessing a third-party application, a tool for performing a web search, or a second AI tool;
direct the first AI tool to generate a first research plan based on the research query and the list of available tools,
wherein the first research plan is a set of instructions to execute one or more of the available tools from the list of available tools, thereby collecting data for responding to the research query;
receive, from the first AI tool, the first research plan;
execute the first research plan;
direct the first AI tool to determine whether the data collected by executing the first research plan is sufficient for a complete response to the research query;
upon receiving an indication from the first AI tool that insufficient data was collected for a complete response to the research query, direct the first AI tool to 1) generate a second research plan based on the research query, the list of available tools, and the data collected from executing the first research plan and 2) execute the second research plan;
direct a third AI tool to generate a response to the research query based on data collected by executing at least one of the first research plan or the second research plan;
receive, from the third AI tool, the response; and
cause display of the response to the user via a user interface.

9. The system of claim 8, further comprising instructions to:
generate, using a fourth AI tool, a human-readable list of steps based on the first research plan;
cause display of the human-readable list of steps to the user via the user interface;
receive, from the user via the user interface, a modification to the first research plan,
wherein the modification includes at least one of an addition of an instruction to the first research plan, a deletion of an instruction from the first research plan, or a supplementary query; and
direct the first AI tool to update the first research plan based on the modification.

10. The system of claim 8, further comprising instructions to:
determine that the research query is complex based on at least one of a detected data environment property, a detected query property, or a user specification of complexity.

11. The system of claim 8, further comprising instructions to:
generate, using a fourth AI tool, a human-readable list of steps based on the first research plan;
direct the third AI tool to generate an intermediate response to the research query based on data collected by executing the first research plan;
receive, from the third AI tool, the intermediate response; and
cause display of the intermediate response to the user via the user interface,
wherein display of the intermediate response includes a status update associated with at least one step from the human-readable list of steps.

12. The system of claim 8, wherein the first research plan comprises:
a subset of the set of instructions for collecting data from a database created by the user,
wherein the database is a table containing data associated with one or more blocks.

13. The system of claim 8, further comprising instructions to:
save the response to a page,
wherein the page is accessible by the user, and
wherein permissions to access the page are controllable by the user.

14. The system of claim 8, wherein executing the first research plan comprises:
selecting two or more instructions from the set of instructions that are executable in parallel,
wherein the selection is based on at least one of a resource limitation or a dependency; and
executing the two or more instructions in parallel.

15. The system of claim 8, wherein executing the second research plan comprises:
accessing a subset of data sources accessed while executing the first research plan.

16. A method comprising:
receiving a research query from a user;
providing a list of available tools to a first artificial intelligence (AI) tool,
wherein the available tools include at least one of a tool for accessing a connected data source, a tool for accessing a third-party application, a tool for performing a web search, or a second AI tool;
directing the first AI tool to generate a first research plan based on the research query and the list of available tools,
wherein the first research plan is a set of instructions to execute one or more of the available tools from the list of available tools, thereby collecting data for responding to the research query;
receiving, from the first AI tool, the first research plan;
executing the first research plan;
directing the first AI tool to determine whether the data collected by executing the first research plan is sufficient for a complete response to the research query;
providing the data collected by executing the first research plan to a third AI tool;
directing the third AI tool to generate a response to the research query based on data provided to the third AI tool;
receiving, from the third AI tool, the response; and
causing display of the response to the user via a user interface.

17. The method of claim 16, further comprising:
upon receiving an indication from the first AI tool that insufficient data was collected for a complete response to the research query, directing the first AI tool to 1) generate a second research plan based on the research query, the list of available tools, and the data collected from executing the first research plan and 2) execute the second research plan;
providing the data collected by executing the second research plan to the third AI tool.

18. The method of claim 16, further comprising:
generating, using a fourth AI tool, a human-readable list of steps based on the first research plan;
causing display of the human-readable list of steps to the user via the user interface;
receiving, from the user via the user interface, a modification to the first research plan,
wherein the modification includes at least one of an addition of an instruction to the first research plan, a deletion of an instruction from the first research plan, or a supplementary query; and
directing the first AI tool to update the first research plan based on the modification.

19. The method of claim 16, further comprising:
receiving, from the user via a second user interface, a selection of data sources to search while executing the first research plan; and
limiting the tools in the list of available tools based on the selection of data sources.

20. The method of claim 16, wherein the first research plan comprises:
a subset of the set of instructions for collecting data from a database created by the user,
wherein the database is a table containing data associated with one or more blocks.
